(19) United States
(12) Patent Application Publication
(10) Pub. No.: US 2010/0053087 A1
(43) Pub. Date: Mar. 4, 2010

(54) TOUCH SENSORS WITH TACTILE FEEDBACK

(75) Inventors: XUNHU DAI, GILBERT, AZ (US); ROBERT CROSWELL, ELGIN, IL (US); JEFFREY PETSINGER, WAYNE, IL (US); DANIEL J. SADLER, GILBERT, AZ (US); GREGORY J. DUNN, ARLINGTON HEIGHTS, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/198,199

(22) Filed: Aug. 26, 2008

(51) Int. Cl. G06F 3/02; G06F 3/044

(52) U.S. Cl. 345/168; 178/18.06

(57) ABSTRACT

Touch sensors with one or more piezoelectric elements and devices containing such touch sensors are presented. The touch sensor contains keys that are independently actuated. Contact with a key provides tactile feedback through the piezoelectric element to the user. Each key provides an individual tactile feedback pattern that is dependent on the particular key contacted as well as the function of the key at the time of contact. Actuation of the key provides a different tactile feedback pattern. The piezoelectric element is bonded directly to a printed circuit board, on which electronic components are also mounted.

### TECHNICAL FIELD

The present application relates to touch sensors. In particular, the present application relates to touch sensors with tactile (haptic) feedback.

### BACKGROUND

Electronic devices typically contain user input arrangements such as keyboards and keypads. Keypads have discrete key locations and are commonly formed using a mechanical switch. Such switches are commonly formed from metal and/or plastic membrane. Tactile feedback is limited in such devices to a single mechanical response as the mechanical switch within the keypad is sufficiently actuated by the user when entering information. Confirmation of completion of the keystroke may be seen on a screen if the device contains a screen.

To a greater extent, electronic devices, and especially portable electronic devices, have been moving to using touch sensors as their primary source of user input. Similar to keypads, touch sensors have discrete key locations through which individual keystrokes can be used to enter information. A detector detects operation of a particular touch key and transmits a signal corresponding to that key.

Unlike keyboards, touch sensor surfaces are flat and key travel does not occur during a keystroke. This limits the amount and type of tactile feedback from the touch sensor to the user, in general providing uncertainty in the user about when a key is activated as well as which key is being activated, thereby causing the user to look at the touch sensor while operating it. Further, any tactile feedback provided may extend throughout the entire touch sensor rather than being localized at the specific key. The use of touch sensors is further problematic under certain conditions, including lack of illumination. Moreover, security issues may arise when using touch sensors to enter personal information, especially touch sensors that are mounted on permanent structures so as to be visible to observers other than the viewer.

### BRIEF DESCRIPTION OF THE DRAWINGS

Embodiments will now be described by way of example with reference to the accompanying drawings, in which:

FIGS. 1A and 1B illustrate one embodiment of a touch sensor.

FIG. 2 illustrates a PCB used in the embodiment of FIGS. 1A and 1B.

### DETAILED DESCRIPTION

Touch sensors with one or more piezoelectric elements are presented. The piezoelectric elements provide individualized tactile feedback for each key of the touch sensor. The piezoelectric elements are bonded directly to a printed circuit board, on which electronic components are mounted. The touch screen may be invisible, that is, seamlessly blend in with the area of the device adjacent to it and not contain any demarcations for the keys. The touch sensor may be incorporated in a portable electronic device such as a cell phone or personal digital assistant (PDA) or a non-mobile device such as a door entry sensor.

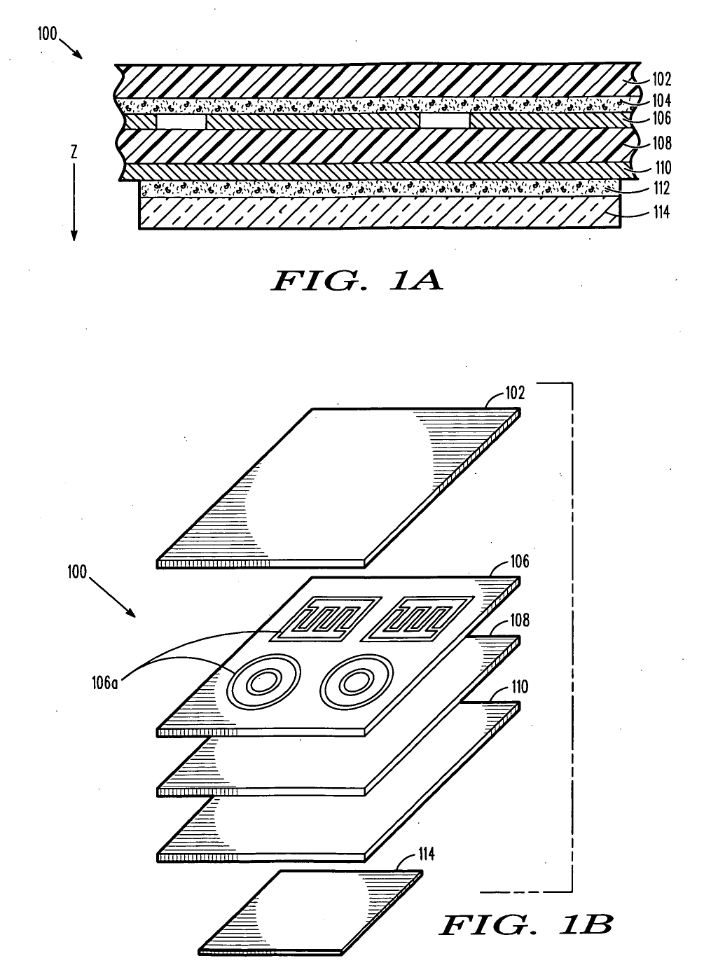

One embodiment of a touch sensor is shown in FIGS. 1A and 1B. The touch sensor 100 includes a number of layers. The layers include a dielectric layer 102, a top conductive layer 106, a printed circuit board (PCB) 108, a bottom conductive layer 110, and a piezoelectric layer 114. Other layers that may be present, such as encapsulation, are not shown for convenience.

The various layers of the touch sensor 100 may have the same or different dimensions. For example, the top conductive layer 106 may have a smaller planar area (i.e., in a plane perpendicular to the z direction shown) than the PCB 108. Similarly, the PCB 108 may be thicker than layers such as the conductive layers 106, 110 and be, for example, 8-15 mils thick. Such a thickness range permits sufficient actuation to be achieved with relatively small voltage (about 100V) applied to the piezoelectric layer 114 without significant warpage occurring to the PCB 108 in the bonding process due to thermal mismatch between the PCB 108 and the piezoelectric layer 114.

Turning to specific layers, the dielectric layer 102 is a top layer that serves as an input surface and provides tactile feedback during contact, e.g., by a finger. This is to say that the dielectric layer 102 is the layer of the illustrated touch sensor 100 that is closest to the user. Although not shown, a thin protective layer of a polymer, rubber, or the like may be disposed on the dielectric layer 102 to protect the dielectric layer 102 from moisture, oil, or other impurities. The dielectric layer 102 is formed from conventional materials such as plastic or glass. The dielectric layer 102 may be a single or multiple layer structure and may be transparent, translucent or opaque.

Below the dielectric layer 102 is a top conductive layer 106. The top conductive layer 106 is formed from a relatively thin (compared to the dielectric layer 102) layer of metal, for example, copper. The top conductive layer 106 may be, for example, a few microns thick. The top conductive layer 106 generally ranges from 5-45 microns, with 17-35 microns being most typical. The top conductive layer 106 may start with one thickness (e.g., 17 microns) and be plated to a greater thickness, e.g., approximately 34 microns, during operations such as plating through hole vias (not shown). As shown, the top conductive layer 106 and the dielectric layer 102 may be attached by a thin adhesive layer 104 or may be deposited or plated on the PCB 108. The adhesive layer 104 may be disposed substantially throughout the area between the dielectric layer 102 and the top conductive layer 106, or may be disposed at a sufficient number of isolated and/or connected locations between the dielectric layer 102 and the top conductive layer 106 to fix the dielectric layer 102 and top conductive layer 106 together. The adhesive layer 104 may be formed from known adhesives such as a solidified liquid layer (e.g., epoxy) or a double-sided adhesive tape. The adhesive layer 104 is an insulating material.

Interdigitated fingers, concentric spirals, or other patterns are formed in the top conductive layer 106. The dielectric layer 102 is thin enough to permit these patterns 106a (shown in FIG. 1B) to serve as capacitive sensors in an array. The patterns 106a sense the presence of an object contacting (or in close proximity to) the dielectric layer 102 using a change in the capacitance of the patterns 106a dependent on the proximity of the object to the patterns 106a. As the object draws closer, the presence/absence of the object can be detected by sensing whether a predetermined threshold change has been reached. The patterns 106a may be the same or may be different, depending on a number of factors including the desired sensitivity of the pattern, the device geometry, and the number of sensing locations desired.

As shown in FIGS. 1A and 1B, the PCB 108 is a single layer structure formed from an insulator such as FR4 (also called a double-sided board). Plated or unplated vias are disposed at various locations in the PCB 108 to provide interconnection between the opposing surfaces of the PCB 108. In other embodiments, the PCB 108 can be a multilayer structure that includes thin metal (e.g., copper) layers sandwiched between thicker insulating layers (e.g., FR4) with vias forming connections between the various layers. The top conductive layer 106 (and the bottom conductive layer 110) contains circuit traces connecting the components. Surface mount components, individual elements (e.g., resistors, capacitors, inductors), and I/O connections are soldered to the PCB 108 and interconnected using the circuit traces. The various components may be soldered to both sides of the PCB 108. Even though the embodiment shown in the figures is substantially rectangular, in practice the PCB 108 may be any shape desired.

The bottom conductive layer 110 is similar in composition and thickness to the top conductive layer 106. The bottom conductive layer 110 may be patterned in a different manner than the top conductive layer 106.

The piezoelectric layer 114 contains plate-like ceramic piezoelectric elements that are directly bonded to the bottom conductive layer 110 through an insulating bonding agent 112 disposed therebetween. No shims or layers other than the bonding agent 112 are disposed between the piezoelectric elements and the bottom conductive layer 110. One example of a suitable bonding agent is Tra-con 931 2-part epoxy. Using this agent, the piezoelectric elements are bonded to the bottom conductive layer 110 at 100° C. for 1 hour using a 600 gram weight on the piezoelectric element. Teflon used between the weight and piezoelectric elements avoids damage to the piezoelectric elements. The piezoelectric elements contact the underlying bottom conductive layer 110 electrically at least in one point. As the bonding agent 112 is non-conductive, the weight thus presses the surfaces of the piezoelectric elements contact the underlying bottom conductive layer 110 in intimate contact in at least one point. In other embodiments, a wire may be attached to the underside of at least one of the piezoelectric elements rather than it contacting the bottom conductive layer 110.

The piezoelectric elements are rigidly attached to the PCB 108 and the only motion comes from the flexing of the PCB 108. The location and size of the keys are determined by the electrical traces on the PCB. In the embodiment shown, the piezoelectric elements provide the only motion for a particular key. Although a different mechanism can be used to generate tactile feedback throughout the touch sensor 100, in the illustrated embodiment, the touch sensor 100 is not attached to any membrane or other mass to induce the mechanical oscillations constituting the tactile feedback.

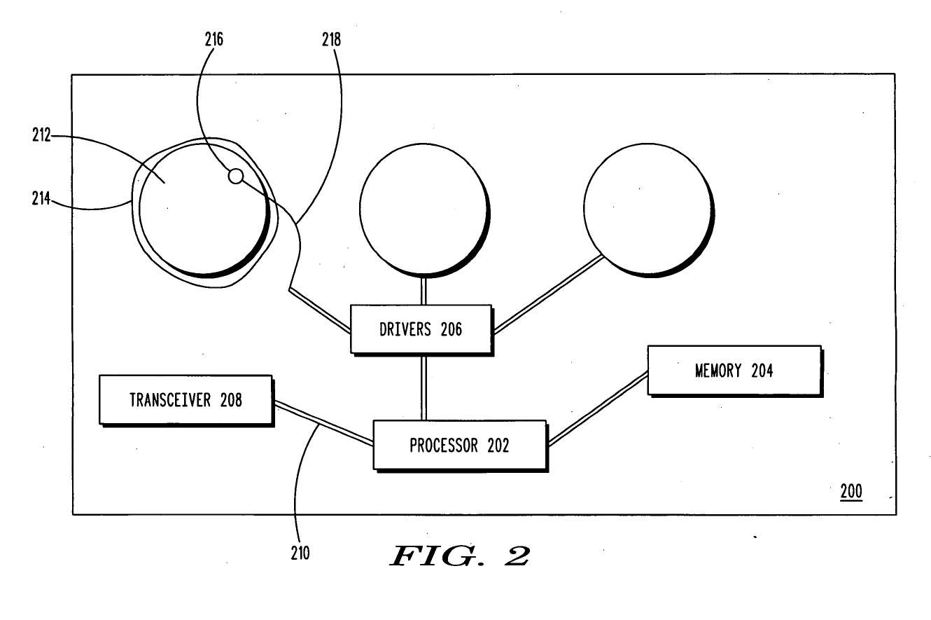

The piezoelectric elements are formed from a piezoelectric material such as barium titanate, lead titanate, lead zirconium titanate, bismuth ferrite, or lithium niobate. The piezoelectric elements may be relatively thin, thereby decreasing the voltage used to drive the piezoelectric elements. The piezoelectric elements may be formed in any shape, for example, rectangular or circular. Example piezoelectric elements that may be used are multiple 20×0.1 mm PZT discs (as illustrated in FIG. 2) or a 35×45×0.2 mm PZT rectangular plate. The piezoelectric elements of the piezoelectric layer 114 may correspond to elements such as keys (not shown) on a keypad of the touch sensor 100.

FIG. 2 shows one embodiment of a PCB. The PCB 200 contains surface mount components including one or more of each of: a processor 202, a memory 204, drivers 206, and a transmitter/receiver (labeled transceiver) 208. Various I/O hardware, power supplies, and individual resistors, capacitors, inductors, diodes, etc. are not shown for clarity. The surface mount components are connected by circuit traces 210. Traces on the opposing side of the PCB 200 are connected through vias (not shown). On the PCB 200, multiple ceramic piezoelectric elements 212 are disposed and connected to the PCB 200 by the bonding agent 214. The processor 202, among other processes, controls driving of the piezoelectric elements 212. The memory 204 stores information for the processor 202, e.g. about the configuration of the keypad. The transceiver 208 permits communication with external devices, e.g., to indicate that the proper code has been entered on the keypad or otherwise to transmit identification information entered on the keypad or to receive configuration information for the keypad (i.e., control functionality of the touch sensor) and then perhaps transmit acknowledgement of the altered functionality.

The piezoelectric elements of the piezoelectric layer each deform laterally in response to an applied voltage, which may be provided by the drivers 206, and thus cause flextentional motion of the bonded piezoelectric/PCB/dielectric structure in the z-direction. The motion produced is proportional to the applied voltage. In different embodiments the motion may be localized to the position of each piezoelectric element rather than being provided over the entire touch sensor or may be provided over the entire touch sensor. Thus, while the haptic response is individualized to a particular key, in these embodiments the haptic response may be provided substantially to only that key rather than being provided to the entire touch sensor or may be provided to the entire sensor. As shown in FIG. 2, the ceramic piezoelectric elements 212 each have a metal upper electrode 216 sputtered or plated thereon. A wire 218 is soldered to the upper electrode 216 using an appropriate flux, such as LO-CO N3, to prepare the piezoelectric surface in order to connect the piezoelectric element 212 to the circuit traces 210 of the PCB 200.

In another embodiment, a single piezoelectric element can be used. The piezoelectric element is disposed to correspond to all of the capacitive sensors. When contact (or close proximity) is made with a particular location corresponding to a key and sensed, the sensed location is provided to the processor on the PCB. The processor then drives the piezoelectric element with a pattern that corresponds to the sensed location, providing a response similar to that of the individualized piezoelectric elements. A similar arrangement can be used in other embodiments in which multiple piezoelectric elements are present but the piezoelectric elements do not have a one-to-one correspondence with the capacitive sensors. Additionally, as long as the appropriate haptic feedback pattern is provided such that the user senses a difference in the haptic feedback when different areas are contacted, the piezoelectric element(s) may not physically correspond to the locations of the keys.

If all of the layers of the touch sensor are relatively thin and directly contact each other, the voltage used to actuate the desired piezoelectric element is minimized to an amount sufficient for a user to feel the response. Such an embodiment, in turn, extends the battery life of a battery supplying the power to the device, if the device is powered by a battery (e.g., in a portable device). When the dielectric layer is contacted (or nearly contacted), the capacitive pattern immediately beneath the dielectric layer senses the contact. The change in capacitance is provided to a comparator, which may be a part of dedicated sensor circuitry or in the processor. The comparator compares the charge differential and transmits a signal to the appropriate driver if the charge differential exceeds a predetermined threshold. The driver, after receiving the signal from the processor, provides a voltage to the piezoelectric element corresponding to the capacitive pattern sensing the contact. The piezoelectric element, in turn, provides haptic feedback to the individual key being contacted through flexing motion of the bonded touchpad structure and thereby provides tactile feedback to a contacting finger.

The haptic feedback provided to the user is dependent on the particular key and function. This is to say that the same key may provide a different tactile feedback pattern dependent on the key function. The key function may be changed by a selector on the touch pad, via a signal from a remote operator, or by the user entering a code on the touch sensor prior to entering personal information. Accompanying the haptic feedback in one embodiment is an associated sound, which helps distinguish the area of the touch sensor being contacted. The sound may be provided by the flexing and unflexing of the layers in the touch sensor due to actuation of the piezoelectric elements or may be provided by integrated or separate sonic or vibrational devices.

Individualization of the haptic feedback permits a user to tell which portion of the touch sensor has been contacted (or is about to be contacted) without viewing the touch sensor. This is helpful, for example, in instances in which the user is unable to view the touch sensor, such as in a dark environment, or in instances in which it may be adverse to look at the touch sensor, such as when driving a vehicle or when playing a video game. Alternately, the touch sensor may be an invisible keypad, a smooth surface without any demarcation associated with the keys (e.g., no outlines, letters, numbers). In the dormant state, the invisible keypad provides no visible or tactile indication of its existence. When actuated, the invisible keypad provides tactile feedback to the user at a virtual button site but still does not provide visible indications. In either case, the user can be oriented to the desired keypad button location by running a finger over the touch sensor surface, receiving tactile feedback confirmation when the desired button is contacted and receiving further tactile feedback confirmation of a different type when the button is depressed.

As above, the tactile feedback pattern can be tailored to both the contact area corresponding to the particular piezoelectric element and to the function of the key when contacted and/or pressed. For instance, patterned clicks for the same contact area may indicate a letter, a number, or a function. To provide tactile feedback to indicate numbers, a haptic pattern containing the corresponding number of single short or long actuations may be used. In addition to varying the pure number of actuations, the length of the actuations may also be varied in a particular pattern to form vibration patterns such as “ZIP” (a vibration that rapidly increases in frequency) or “RUMBLE” (a long vibration at low frequency). Such patterns may be used to avoid the user having to count to higher numbers (e.g., above 4 or 5) of actuations as this leads to an increased chance of losing track due to an interruption or lapse of concentration. Touch sensors incorporating individualized haptic feedback may be customized with personalized non-numeric haptic feedback patterns. The haptic feedback patterns may be programmable, downloadable, or otherwise selectable.

If two or more positions corresponding to different piezoelectric elements are contacted at the same time, the particular haptic feedback pattern(s) may be selected as determined by rules in the processor that are unalterable or are programmable by the user. For example, the haptic feedback pattern of the first or last position to be sensed may be used. Alternately, a combination of haptic feedback patterns may be used. In this latter case, the various individual haptic feedback patterns may be interleaved with each other. In an alternative embodiment, other patterns can be used, for example, the first haptic feedback pattern is actuated once to indicate that it was sensed first, the second haptic feedback pattern is actuated twice to indicate that it was sensed second, etc.

In addition to the capacitive sensor array, the touch sensor may also contain a pressure sensing mechanism coupled to the PCB. The pressure sensing mechanism may be, for example, force sensing resistors, strain gauges, microelectromechanical-based force sensing resistor arrays, or piezoresistive or piezoelectric elements. In one embodiment, the capacitive sensors sense the static presence of the object on or near the dielectric layer while the pressure sensing mechanism senses both static and dynamic variation of the applied pressure. If the object applies a pressure greater than that of a predetermined threshold (the predetermined pressure), a signal is sent to the processor. The processor transmits a signal to the driver to actuate the appropriate piezoelectric element and thereby indicate that the corresponding area has been contacted with the predetermined pressure.

Once the predetermined pressure is detected, the haptic feedback pattern initiated by the signal from the capacitive sensors is terminated and a new haptic feedback pattern initiated by the signal from the pressure sensing mechanism is used. The haptic feedback pattern provided due to the predetermined pressure being applied may be the same or different for all piezoelectric elements, e.g., a single snap that provides the feeling of a button click or popple (metal dome) reflex to the user. The haptic feedback pattern provided as a result of the pressure sensing mechanism being actuated may be the same as or different than the haptic feedback pattern provided when the capacitive sensors sense the presence of the object.

Although the above embodiment contains a pressure sensing mechanism, in other embodiments, the pressure sensitive mechanism may be eliminated. In this case, the piezoelectric elements can serve to sense button depression as well as only sensing contact. The sensor function exploits the charge (and thus voltage) generated when the applied pressure induces a strain in the piezoelectric material. However, this charge is generated only under dynamic conditions, that is, when the sensor experiences a change in strain with respect to time. While this configuration is simpler, cheaper, and useful in certain applications such as ON-OFF operations it is not appropriate for other uses. For example, the piezoelectric elements do not sense a sustained button pressure such as would be applied, for example, to change the volume of a cell phone.

The touch sensor may have an activation mechanism such that, before activation, the touch sensor does not respond to either contact or pressure thereon. For example, the touch sensor may be activated wirelessly, (e.g., via Bluetooth) by a separate device using the transceiver 208 on the PCB 200. In another embodiment, rather than wireless activation, a fingerprint, voice, or retinal sensor may be used to activate the touch sensor such that the touch sensor is active only when a registered user handles the device. Alternatively, the touch sensor can be activated by entry of a code on a conventional keypad disposed on a different portion of the device. In an example of such an embodiment, the touch sensor may be disposed at a location proximate to the conventional keypad, e.g., the back surface of a cell phone or PDA. The touch sensor may be activated by code entry on the conventional keypad on the front surface of the device.

If the keypad is invisible, it may be disposed in a location proximate to the activation mechanism. For example, an invisible keypad used for a briefcase combination lock may be concealed in the briefcase handle and activated by a concealed mechanical switch within the handle connector assembly. The switch may be open when the handle is pulled away from the briefcase, as naturally occurs when the briefcase is lifted and carried by the handle. In this mode, the invisible keypad is de-activated, so that when a person other than the briefcase owner carries the case he cannot feel the keypad. Similarly, the invisible keypad may be disposed in the handle of a suitcase or other types of cases.

In another example, the invisible keypad can be used as an ATM or entry keypad for entering Personal Identification Numbers (PINs) in a manner similar to the above. In this case, as in the others above, rather than the keypad being completely blank, the keypad can contain artwork indicating the locations of the virtual buttons. For added security, the symbol-number assignments may be randomly changed every time or every predetermined number of times the ATM is used or a PIN number is entered correctly, and can be translated only through touch. In this manner, even if someone surreptitiously watches which virtual button locations are pushed, the PIN number entered may not be readily apparent. This is also useful for e-commerce in which a keypad is used to enter a PIN number to make a purchase, and the device does not have a physical shroud to conceal the PIN number entry.

Similarly, the positional assignments of the numbers in an invisible keypad can be changed every time or every predetermined number of times the touch sensor is used or is temporally dependent (e.g., changes every 30 minutes, hour, day, at specific times of the day, etc.). The number assignments can change randomly or change in a predetermined pattern. This enables security enhancements for a variety of home, vehicle, and personal possessions.

Although not shown, the touch sensor may contain or be wirelessly or wireline linked with an output device such as a screen or printer. This device may provide visual indications of contact and/or entry from the keypad to the user or to a remote viewer. In the latter case, the remote viewer may be, for example, a controller in an operations room to which the user is attempting to gain access or a network operator located in a different area as the keypad. The visual indications may be either the actual number or letter or a generic symbol such as a star to mask the identity of the number or letter. If a screen is used to provide the visual indications, the number or letter may be provided in one color to indicate a provisional selection (i.e., contact without the predetermined pressure being applied) and another color to indicate final selection (i.e., once the predetermined pressure has been applied). As before, the visual indications may be unalterable or adjusted by the user.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Those skilled in the art will recognize that a wide variety of modifications, alterations, and combinations can be made with respect to the above described embodiments without departing from the spirit and scope of the invention defined by the claims, and that such modifications, alterations, and combinations are to be viewed as being within the scope of the inventive concept. Thus, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by any claims issuing from this application and all equivalents of those issued claims.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A touch sensor comprising:
a dielectric layer having discrete locations that each correspond to a distinct key;
a piezoelectric element; and
a PCB on which top and bottom conductive layers are disposed on opposing surfaces, the PCB disposed between the dielectric layer and the piezoelectric element and connected to the dielectric layer and the piezoelectric element such that no layer other than bonding layers that bond the dielectric layer and the PCB and the piezoelectric element and the PCB is present between the dielectric layer and the PCB and the piezoelectric element and the PCB, at least one of the top and bottom conductive layers containing circuitry formed therein and components disposed thereon, the touch sensor configured to sense when contact with one of the discrete locations of the dielectric layer is made and in response actuate the piezoelectric element to provide individualized tactile feedback dependent on the contacted discrete location.

2. The touch sensor of claim 1, wherein the circuitry contains capacitive traces that are disposed to each correspond to a unique one of the discrete locations, each capacitive trace sensing contact with the corresponding discrete location capacitively.

3. The touch sensor of claim 1, wherein the components include a pressure sensing mechanism that senses whether a predetermined pressure has been provided after contact with the dielectric layer has been made, tactile feedback being provided in response to the pressure sensing mechanism sensing that the predetermined pressure has been provided, the tactile feedback being provided in response to the pressure sensing mechanism sensing that the predetermined pressure has been provided being different from the individualized tactile feedback provided in response to contact with the dielectric layer being sensed.

4. The touch sensor of claim 1, wherein the individualized tactile feedback is dependent on both the location of the contacted discrete location and a function of the discrete location when the discrete location is contacted, the function of the discrete location being different at different times.

5. The touch sensor of claim 1, wherein at least some of the discrete locations correspond to different numbers, at least one of the individualized tactile feedback responses is a number of actuations corresponding to the number of the discrete location and at least another of the individualized tactile feedback responses is an actuation pattern other than a number of actuations corresponding to the number of the discrete location.

6. The touch sensor of claim 1, wherein the piezoelectric element is configured to sense the application of pressure above a predetermined threshold at the contacted discrete location.

7. The touch sensor of claim 1, wherein the components comprise a receiver configured to permit wireless communication with an external device to control functionality of the keys.

8. The touch sensor of claim 1, further comprising an activation mechanism to activate the touch sensor, the touch sensor having a dormant state in which the touch sensor does not respond to contact or pressure on the touch sensor and an active state in which the touch sensor responds to contact or pressure on the touch sensor.

9. The touch sensor of claim 1, further comprising a plurality of piezoelectric elements each of which is disposed to correspond to a different discrete location and is activated in response to contact being made with the corresponding discrete location to provide the individualized tactile feedback.

10. The touch sensor of claim 9, wherein number assignment of the keys is changed dependent on touch sensor use or is temporally dependent.

11. The touch sensor of claim 9, further comprising a receiver configured to receive a signal from an activation mechanism to activate the touch sensor.

12. The touch sensor of claim 9, further comprising a transmitter configured to transmit a value corresponding to the contacted discrete location to a visual display.

13. The touch sensor of claim 1, wherein, if multiple discrete locations are contacted at the same time, the touch sensor is configured to provide tactile feedback dependent on only one of the contacted discrete locations.

14. A device comprising an invisible keypad having keys configured to be physically touchable by a user and a piezoelectric element disposed within the keypad, the keypad configured to sense when contact with one of the keys is made and in response actuate the piezoelectric element to provide individualized tactile feedback dependent on the contacted key.

15. The device of claim 14, the keypad further comprising a pressure sensing mechanism that senses whether a predetermined pressure has been provided after contact with one of the keys has been made, tactile feedback being provided in response to the pressure sensing mechanism sensing that the predetermined pressure has been provided, the tactile feedback being provided in response to the pressure sensing mechanism sensing that the predetermined pressure has been provided being different from the individualized tactile feedback provided in response to contact being sensed with the one of the keys.

16. The device of claim 14, the keypad further comprising a receiver configured to receive a wireless signal from an activation mechanism to activate the device.

17. The device of claim 14, further comprising an activation mechanism to activate the keypad, the keypad remaining in a dormant state until activated by the activation mechanism, no tactile feedback being supplied by the piezoelectric element when the keypad is in the dormant state.

18. The device of claim 17, wherein the device comprises a portable electronic device in which the activation mechanism is triggered by entry of a code into a conventional keypad.

19. The device of claim 17, wherein the device comprises a combination lock, the activation mechanism comprises a mechanical switch, and the switch is actuated to deactivate the invisible keypad.

20. The device of claim 14, wherein assignment of the keys is changed dependent on the number of times the keypad has been used, on the number of times a correct input has been entered, or on the time since the last time the key assignment has been changed.
